(19) United States
(12) Patent Application Publication
(10) Pub. No.: US 2024/0262442 A1
(43) Pub. Date: Aug. 8, 2024

(54) SYSTEMS AND METHODS FOR SUPPORTING MOTORCYCLE PARKING

(71) Applicant: Paul Yaffe, Phoenix, AZ (US)

(72) Inventor: Paul Yaffe, Phoenix, AZ (US)

(21) Appl. No.: 18/165,160

(22) Filed: Feb. 6, 2023

(51) Int. Cl. B62H 1/02

(52) U.S. Cl. CPC B62H 1/02

(57) ABSTRACT

A system may be configured to improve a kickstand's installation and use. Some embodiments may involve provision of a main body configured to be disposed onto both the kickstand and a motorcycle, the motorcycle being supported when not in motion via these dispositions. The main body may comprise upper and lower portions, the upper and lower portions respectively having first and second holes. The first holes may be used for coupling therethrough the upper portion of the main body via one or more fasteners to a motorcycle's frame. The kickstand may also be coupled to the lower portion of the main body, via the second holes and one or more other fasteners, resulting in a different angle from an angle created by a direct coupling of the kickstand to the motorcycle.

### TECHNICAL FIELD

The present disclosure generally relates to systems and methods for fixing an installation, and subsequent use, of a motorcycle kickstand.

### BACKGROUND

Some kickstand styles, such as the ones on original equipment manufacturer (OEM) Milwaukee 8 (M8) Harley-Davidson® cruiser-style motorcycles (including, but not limited to, the Harley-Davidson Softail®, Street Bob®, Low Rider®, Fat Boy®, Deluxe, Slim, Sport Glide, and Heritage Classic model motorcycles) may be originally mounted on motorcycles. Installations of some kickstands onto motorcycles often cause an initial contact of the kickstand to be at a problematic angle with respect to the ground. FIG. 2 depicts an example of this angle, which may be greater than a preferred angle and which is shown in relation to an arrow that indicates a direction of a leaning motorcycle when parking.

When the kickstand is lowered or otherwise deployed into an activated state and when the immobile motorcycle is leaned toward the side where the kickstand is mounted, the kickstand may interact with the ground such that it digs into the ground, causing the kickstand to be stuck into the ground or improperly deployed without locking the motorcycle kickstand into the extended position. When the kickstand is not locked in the activated state, the kickstand may remain rotatable and may unexpectedly return to its raised position. An operator of this motorcycle may then inadvertently allow the motorcycle to fall over, incorrectly thinking the kickstand is properly activated, engaged, and secured, upon the motorcycle rolling slightly forward due to momentum, gravity, or the kickstand spring raising the kickstand.

### SUMMARY

Systems and methods are disclosed for improving a kickstand's installation onto a motorcycle such that the kickstand securely slides into position and locks itself in place, reducing the risk of the motorcycle subsequently falling over. Accordingly, one or more aspects of the present disclosure may involve provision of a main body configured to be disposed onto both a kickstand and a motorcycle, the motorcycle being supported when not in motion via these dispositions. The main body may comprise upper and lower portions, the upper and lower portions respectively having first and second holes. The first holes may be used for coupling therethrough the upper portion of the main body via one or more fasteners to a motorcycle's frame. The kickstand may be coupled to the lower portion of the main body, which, in some embodiments, will cause the kickstand to have an angle that is different from an angle created by an original coupling of the kickstand to the motorcycle.

Implementations of any of the described techniques and architectures may include a method or process, an apparatus, a device, a machine, a system, or processor-executable instructions stored on a computer-readable storage device.

### BRIEF DESCRIPTION OF THE DRAWINGS

The details of particular implementations are set forth in the accompanying drawings and description below. Like reference numerals may refer to like elements throughout the specification. Other features will be apparent from the following description, including the drawings and claims. The drawings, though, are for the purposes of illustration and description only and are not intended as a definition of the limits of the disclosure.

FIG. 1A illustrates a plan view of a front of a side-stand adjustment device, in accordance with one or more embodiments.

FIG. 1B illustrates upper and lower portions of the side-stand adjustment device, in accordance with one or more embodiments.

FIG. 2 illustrates a plan view of a front of a kickstand, in accordance with the prior art.

FIG. 3 illustrates a perspective view of the side-stand adjustment device, in accordance with one or more embodiments.

FIG. 4 illustrates another perspective view of the side-stand adjustment device, in accordance with one or more embodiments.

FIG. 5 illustrates a plan view of a right side of the side-stand adjustment device, in accordance with one or more embodiments.

FIG. 6 illustrates an example of a top view of the side-stand adjustment device, in accordance with one or more embodiments.

FIG. 7 illustrates an intermediate step in a process of mounting the side-stand adjustment device onto a frame of a motorcycle, in accordance with one or more embodiments.

FIG. 8 illustrates the side-stand adjustment device after being mounted onto the frame of the motorcycle, in accordance with one or more embodiments.

FIG. 9 illustrates a final step in a process of mounting the kickstand onto the mounted side-stand adjustment device, in accordance with one or more embodiments.

FIG. 10 illustrates an example of the kickstand originally mounted without the side-stand adjustment device while the kickstand is in a lowered position, while beginning to lean the motorcycle, in accordance with the prior art.

FIG. 11 illustrates an example of the kickstand mounted with the interposed side-stand adjustment device while the kickstand is in a lowered position, while beginning to lean the motorcycle, in accordance with one or more embodiments.

FIG. 12 illustrates a close-up view of an improved rake angle due to the interposed side-stand adjustment device, in accordance with one or more embodiments.

FIG. 13 illustrates a close-up view of the original, deficient rake or height of the kickstand foot prior to leaning the motorcycle, in accordance with the prior art.

FIG. 14 illustrates an example of an improved rake or height of the kickstand foot due to the interposed side-stand adjustment device, in accordance with one or more embodiments.

FIG. 15 illustrates an example of the kickstand lifted out of an activated state while not leaning the motorcycle, in accordance with one or more embodiments.

FIG. 16 illustrates an example of the kickstand lowered from the deactivated state while leaning the motorcycle, in accordance with one or more embodiments.

FIG. 17 illustrates an example of the lowered and locked kickstand after completing the leaning of the motorcycle, in accordance with one or more embodiments.

FIG. 18 illustrates a process for adjusting a configuration of a kickstand installation, in accordance with one or more embodiments.

### DETAILED DESCRIPTION

As used throughout this application, the word “may” is used in a permissive sense (i.e., meaning having the potential to), rather than the mandatory sense (i.e., meaning must). The words “include,” “including,” and “includes” and the like mean including, but not limited to. As used herein, the singular form of “a,” “an,” and “the” include plural references unless the context clearly dictates otherwise. As employed herein, the term “number” shall mean one or an integer greater than one (i.e., a plurality).

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are in contact with each other without any intermediate parts or components. As used herein, “fixedly coupled” or “fixed” means that two components are coupled so as to move as one while maintaining a constant orientation relative to each other. Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

These drawings may not be drawn to scale and may not precisely reflect structure or performance characteristics of any given embodiment, and should not be interpreted as defining or limiting the range of values or properties encompassed by example embodiments.

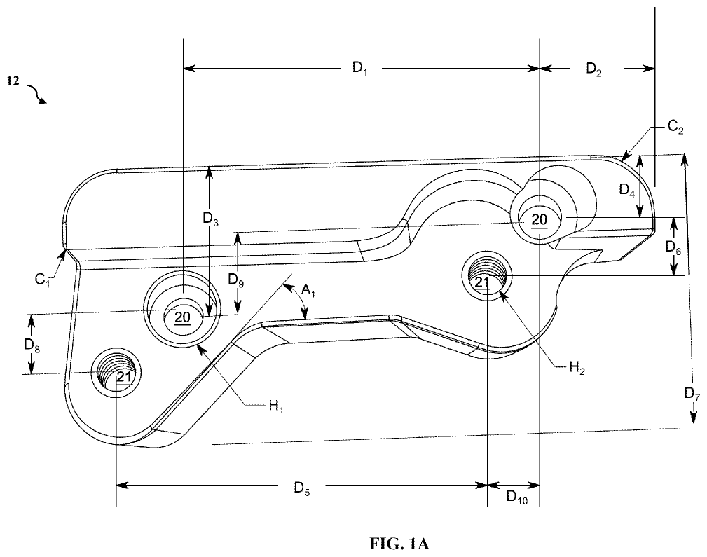

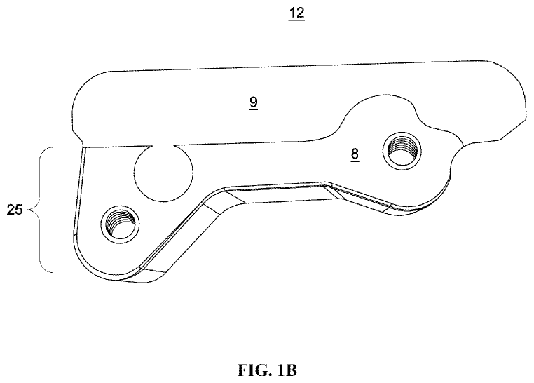

Presently disclosed are ways of improving the deployment and use of a kickstand, when a parked motorcycle or another type of vehicle is leaned to rest on it. A contemplated main body, which is exemplarily shown in FIG. 1A, may change the angle of the OEM kickstand assembly, lower it, and/or adjust a degree)(° of a lean of the motorcycle when placed on the kickstand. For example, the angle of the kickstand relative to the motorcycle's frame and the ground may be changed, and these changes may both result from disposing main body 12 between the kickstand and the frame, as opposed to an original coupling of the kickstand directly to the frame.

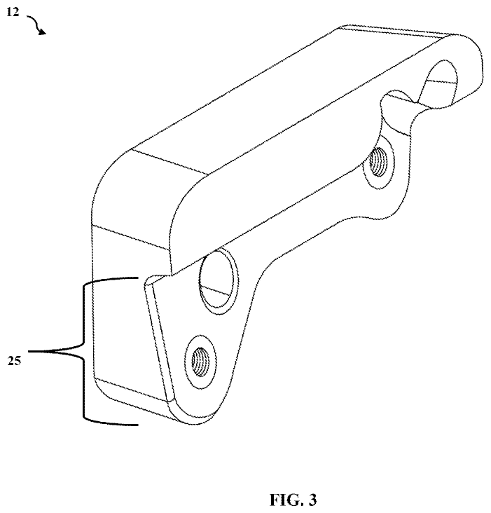

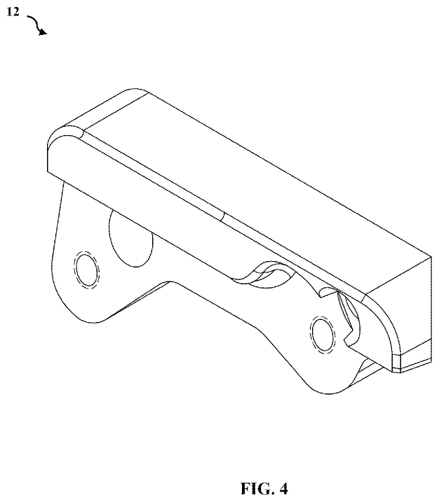

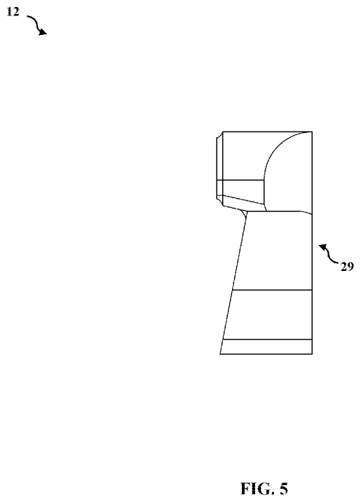

FIGS. 3-4 depict different views of the side-stand adjustment device, in accordance with one or more embodiments. In the example of FIG. 3, protrusion 25 may be configured to be thicker while proceeding vertically down a front face of lower portion 8 of main body 12. This contemplated thickening or another set of physical features of main body 12 may, e.g., cause the aforementioned changes when kickstand 14 is subsequently mounted thereon. FIG. 5 further shows an example of this thickening of the lower portion by depicting a plan view of a right side of main body 12.

Further, the herein-disclosed means for adjusting the angle of the kickstand may have the added benefit of protecting the kickstand spring by positioning it in a place where, when raised, it is less likely to hit the ground or other obstacle (e.g., when going over a bump or up a steep trailer ramp or driveway to a flat area or going up or down over a curb). This improved orientation may also protect the kickstand spring from being damaged when trailering the motorcycle (i.e., when the motorcycle's suspension is compressed from securing the motorcycle in place, which should always be done with the kickstand in the raised position).

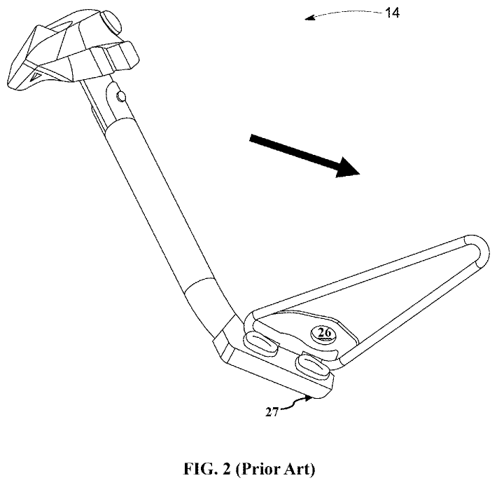

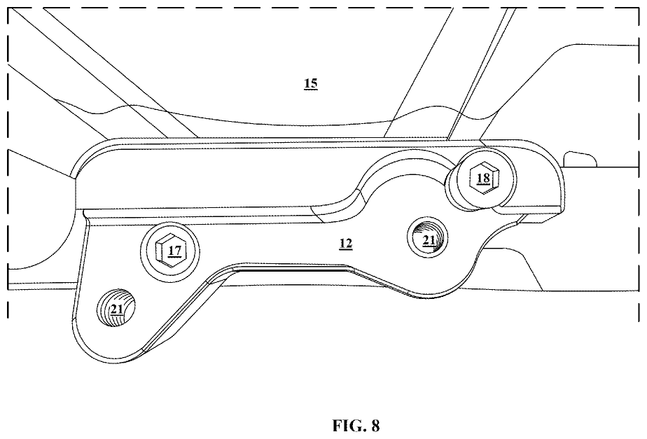

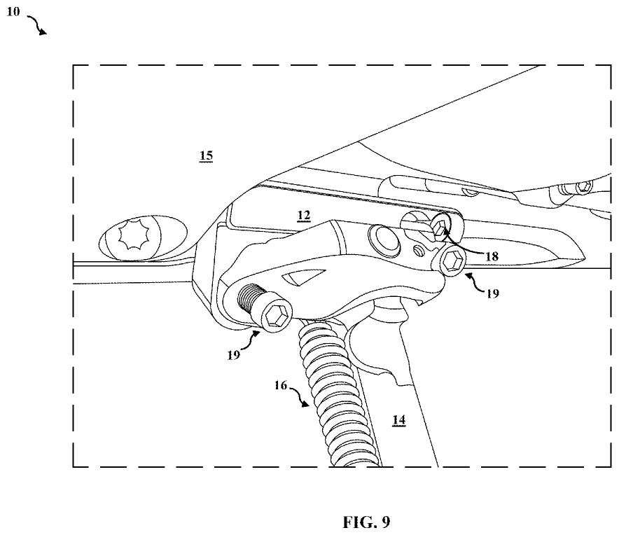

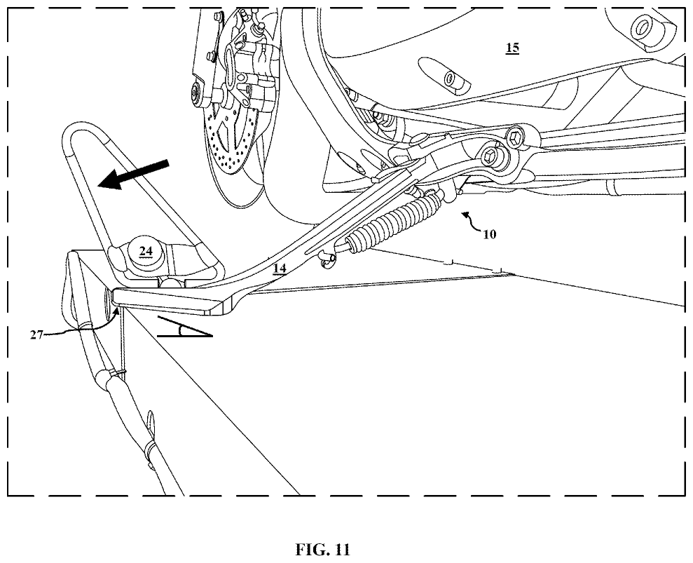

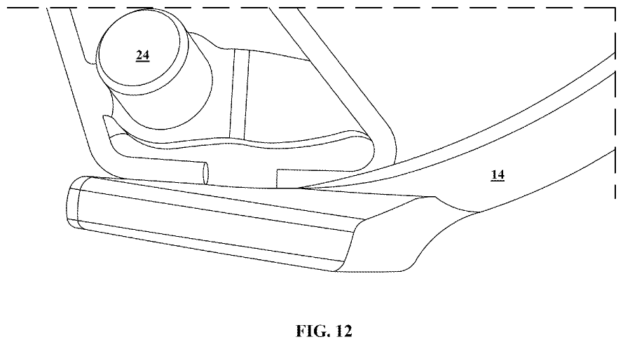

In some embodiments, side-stand support assembly 10 may comprise main body 12 (e.g., billet block, bar of metal, or other structure comprising a main body) and kickstand 14 (e.g., OEM equipment on Harley-Davidson M8 Softail series motorcycles), an example kickstand being depicted in FIG. 2. In these or other embodiments, side-stand support assembly 10 may be configured to augment a kickstand installation at motorcycle 15. For example, the kickstand may initially be removed from a frame of the motorcycle and then reinstalled thereat using at least the main body. In this or another example, one or more fasteners 17,18 may be used for directly coupling main body 12 to motorcycle 15, and/or one or more fasteners 19 may be used for directly coupling kickstand 14 to the side-stand adjustment device such that that device interposes the motorcycle's frame and the kickstand. FIGS. 1A and 7-9 depict examples of the interposition of main body 12 between motorcycle 15 and kickstand 14. As a result, rake may be added for the re-installed kickstand, as shown in the example of FIGS. 11-12 and 14, or height of the kickstand foot may be increased. For example, a height of the kickstand foot in the lowered position may increase when the kickstand angle increases such that, as the rake increases, the height may increase (e.g., assuming that the mounting position stays the same). The herein-disclosed approach may increase the rake but also may lower the kickstand mounting point.

As shown in the preferred example of FIG. 1A, dimension 1 (D₁) may be about 3.2 inches (3.2″), D₂ may be about 0.828″, D₃ may be about 1.35″, D₄ may be about 0.402″, D₅ may be about 3.2″, D₆ may be about 0.625″, D₇ may be about 2.30″, Da may be about 0.625″, Do may be about 0.75″, and D₁₀ may be about 0.5″. Also, as shown in the example of FIG. 1A, angle 1 (A₁) may be about 46.9°, curvature 1 (C₁) may have a radius of about ⅛″, and C₂ may have a radius of about ½″. Similarly, inner diameter of holes 20 (H₁) may be about 0.40″ thru all, outer diameter of these holes may be about 0.63″, and holes 21 (H₂) may be characterized as having a diameter of about 0.31″ thru all and as ⅜-16 unified coarse pitch threads (UNC) thru all.

In some embodiments, holes 21 may be 0.5″ in front of holes 20 such that main body 12 moves kickstand 14 forward by 0.5″, e.g., on one or both ends. In these or other embodiments, main body 12 may relocate kickstand 14 forward or rearward from its original mounting position. For example, a range of horizontal movement may be between 0.25″ to 1.5″ forward or backwards.

In some embodiments, one or more holes 20, e.g., at upper portion 9 of main body 12, may be configured to allow one or more fasteners 17, 18 respectively to pass therethrough to couple the main body to an outer region of motorcycle 15. For example, one or more bolts 17, 18 may facilitate this coupling by being respectively screwed into one or more threaded holes 22 of (e.g., a frame of) motorcycle 15 at or near a bottom region of the motorcycle. In these or other embodiments, one or more threaded holes 21, e.g., at lower portion 8 of main body 12, may be configured to allow one or more fasteners 19 to respectively screw on or otherwise couple kickstand 14 onto the main body. In either or both of these couplings, about 30-45 pound-feet (lb·ft) of torque may be applied.

In some embodiments, holes 20, 21, 22 may all have same or similar dimensions (e.g., diameters and/or depths may be substantially the same).

In some implementations, motorcycle 15 may be held up or otherwise dispositioned so that fasteners 19, which may attach kickstand 14 to a frame of the motorcycle, are removed. For example, the kickstand may be removed as one complete assembly (e.g., without substantially affecting spring 16), and then these stock fasteners may be retained. In these or other implementations, one or more new fasteners 17, 18 (e.g., and some additional hardware for bumper 24 of kickstand 14) may be provided; they may be of the same length or one such fastener may be longer than the other(s), and/or they may be longer than the OEM fasteners. For example, fastener 18 may be inserted at a back of main body 12, and fastener 17 may be inserted at a front of main body 12. In this or another example, an adhesive (e.g., Loctite, Vibra-tite, or other threadlocking substance) may be applied to the fasteners mentioned herein to provide a more secure coupling.

In some embodiments, one or more holes 20 of main body 12 may align with one or more holes 22 of a frame of motorcycle 15.

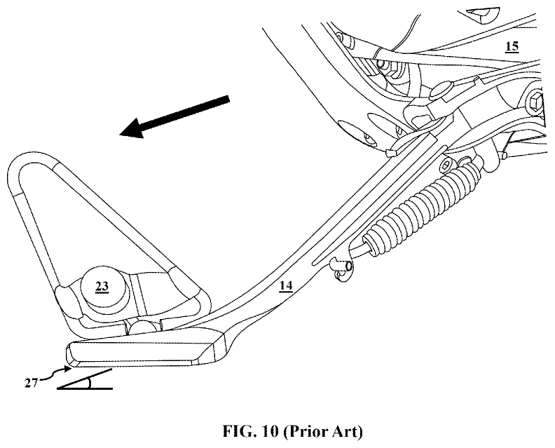

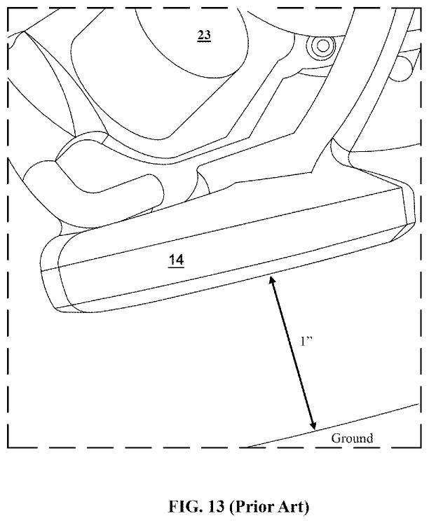

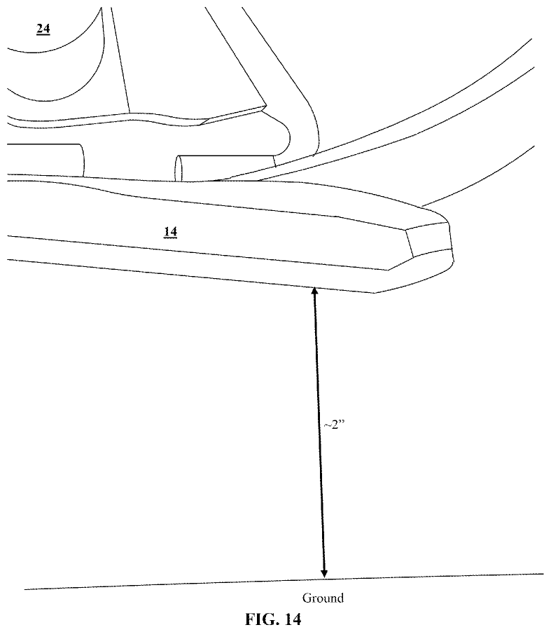

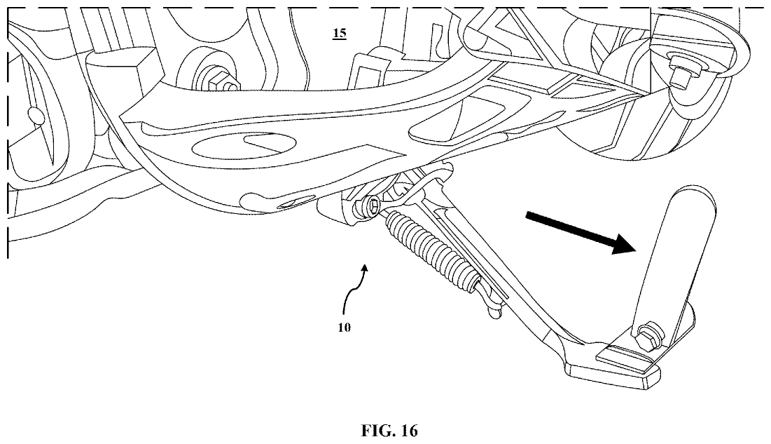

In some implementations, as shown in the exemplary adjustment from FIG. 13 to FIG. 14, after main body 12 is installed, the rake of the kickstand 14 in its lowered position may be increased compared to the rake present when the kickstand 14 is installed directly on the motorcycle 15 without the main body 12. For example, motorcycle 15 may be caused to lean over farther, when it is rested on the kickstand 14 when the main body 12 is installed between the kickstand 14 and the motorcycle 15. In these or other implementations, as shown in the exemplary adjustment from FIG. 10 to FIG. 11, after main body 12 is installed, an angle of approach of flat, bottom surface 27 of the kickstand is adjusted to the extent that the angle itself becomes substantially changed (e.g., inverted, of a different sign, or about 90° different) from the original configuration. For example, the angle depicted in the example of FIG. 11 may be due to the outer portion of flat, bottom surface 27 of kickstand 14 pointing upward in relation to the ground. In this or another example, an outer portion (e.g., the left edge viewed in FIG. 10) of the kickstand's foot may point slightly downward, as in FIG. 10. But after installing main body 12, as shown in FIG. 11, the left edge of that foot may point slightly up, preventing the foot from digging into the ground and preventing the kickstand from safely latching and/or engaging when motorcycle 15 is rested on kickstand 14. In FIGS. 10-11 (and again in FIG. 16), an arrow shows a direction of a leaning of motorcycle 15.

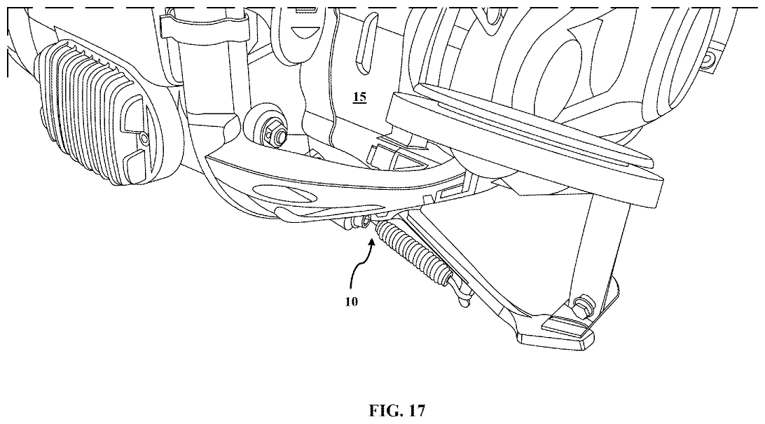

FIGS. 10 and 13 thus depict the kickstand assembly without main body 12, and FIGS. 11 and 14 depict the kickstand assembly with main body 12. As a result, after that flat, bottom surface of kickstand 14 approaches and then contacts the ground, as shown in the example of FIG. 16, the locking mechanism thereabout on kickstand 14 may smoothly engage, as shown in the example of FIG. 17, i.e., without encountering substantial interference or another type of problematic contact.

In some embodiments, after being installed, kickstand 14 may securely transition into its locked position without digging into the ground surface (e.g., concrete, pavement, asphalt, gravel, dirt, grass, mud, etc.) due to kickstand 14 being raked via the interposition of main body 12. As a further result, motorcycle 15 may be given a greater lean angle (e.g., an increase of about 4°) compared to the lean angle when the kickstand 14 is coupled directly to the motorcycle 15 with the main body 12, thereby providing more security that the kickstand is indeed locked, that the motorcycle is held in place, and that it is less likely to be tipped over in the direction opposite the kickstand 14. And, for motorcycles that are lowered from their stock configuration (e.g., using a lowering kit, due to a wheel size being changed, or when the suspension is changed), the lean angle lost from that lowering may actually be returned and thus increased for more security through the coupling of main body 12 between kickstand 14 and motorcycle 15.

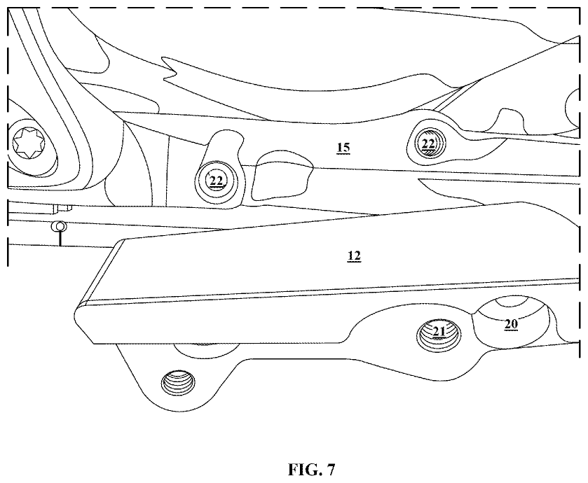

In some embodiments, the coupling of kickstand 14 onto main body 12 (e.g., at about lower portion 8) may operationally cause a locking of the kickstand that is previously unattainable via an original coupling of that kickstand onto the motorcycle (i.e., without use of that main body). For example, by interposing main body 12 (e.g., as shown in FIGS. 7-9 and 11) and then while leaning motorcycle 15 upon kickstand 14 in its lowered position, the kickstand may not dig into a ground or floor. That is, the kickstand's initial contact with the ground or floor may not preclude the fully intended kickstand motion that culminates in said locking of the kickstand in its lowered position. When the kickstand is not locked, the head of the kickstand is rotatable; and, when locked, the head of the kickstand is not rotatable, which indicates a desired configuration for the parked motorcycle.

In some embodiments, changing an angle of kickstand 14 with main body 12 may also change an angle of the kickstand itself. As a result, the way bumper 23 contacts motorcycle 15 may be undesirable to some operators. Accordingly, bumper 23 is contemplated as being replaced with bumper 24. For example, after interposing main body 12 between motorcycle 15 and kickstand 14, bumper 23 may miss a primary contact region or notch of the motorcycle (and the heel tab may instead problematically make contact there or in another undesired location) when the kickstand is returned to a deactivated (i.e., raised) state. In this or another example, the changed angle may be compensated, e.g., by replacing removed bumper 23 with other bumper 24 using some complementary hardware. In some embodiments, rear surface 29 of main body 12 (e.g., FIG. 5) may be parallel to the surface of the frame on which it mounts and to the vertical axis of the motorcycle. For example, rear surface 29 may be generally perpendicular to the ground when the motorcycle is raised off its kickstand to its full upright position (i.e., not leaning either left or right). The angle at which the surface of lower portion 8 is disposed may add 5°-13° of rake to the kickstand over stock and, in the preferred embodiment, may add 11° of kickstand rake (i.e., rakes the kickstand 11° counterclockwise when viewed from the front of the motorcycle). In some implementations, main body 12 may lower the kickstand between 0.5″ and 1.5″ compared to the kickstand's height when mounted directly to the frame without main body 12 (i.e., in its OEM/stock mounting position). In the preferred embodiment, disposition of main body 12 between kickstand 14 and motorcycle 15 lowers the kickstand by 0.625″ from its original mounting position (i.e., compared to the kickstand's height without main body 12).

In some implementations, replacement bumper 24 may be taller than original bumper 23 (e.g., with a height increase of about 0.25″ to 0.75″). In these implementations, bumper 24 may have about a same diameter as bumper 23, but in other implementations bumper 24 may be larger in diameter. The material used to manufacture bumper 24 may be substantially the same as bumper 23, e.g., being a heat-resistant rubber, and, in all instances, should be a material that can withstand temperatures of at least 250° Fahrenheit. In certain embodiments, the material used to manufacture bumper 24 can withstand temperatures of at least 750° Fahrenheit

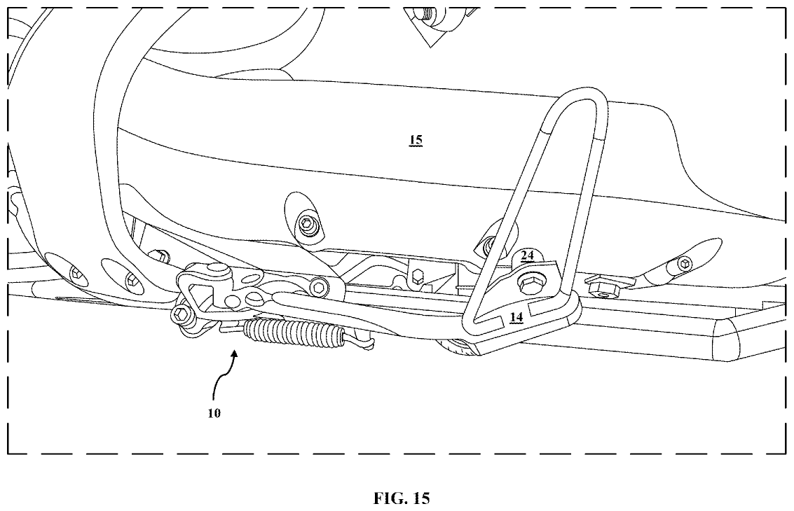

In some embodiments, OEM kickstand bumper 23, which is depicted in the example of FIG. 10, may be removed (e.g., by prying and releasing an interference fit or removing a fastener securing it), and then the complementary hardware may be used to couple replacement bumper 24 to a lower region of kickstand 14, as shown in the example of FIG. 11. For example, a lock washer may be used to fill hole 26 (FIG. 2) on one or both sides of the lower region of kickstand 14 that is uncovered by removing bumper 23. A flat washer may also be used to directly couple with one of those lock washers and with the lower region of the kickstand where the fill hole is, this one washer or the other washer being further used to center a newly provided fastener that may extend through the washers and the lower region before the direct coupling at (e.g., a tightening into) bumper 24. As a result, bumper 24 on kickstand 14 may properly contact motorcycle 15 when the kickstand is in the deactivated or raised state, as shown in the example of FIG. 15.

As shown in the example of FIG. 1B, main body 12 may in some implementations comprise protrusion 25 (e.g., at a front surface of the main body) for protecting spring 16 of kickstand 14, e.g., when the kickstand is in its raised and deactivated state. This protrusion 25 in the front may operate to protect this spring from being impacted, e.g., when motorcycle 15 drops off a curb, encounters a tall speed bump, or traverses an inclined surface (e.g., a ramp or driveway apron) onto a flat surface (e.g., a trailer bed or driveway).

The example of FIG. 1B further shows upper and lower portions 9 and 8, respectively. For example, these portions may each have a (e.g., flat) plane, the plane of portion 9 generally being at a higher height with respect to portion 8 and the ground or floor when installed on motorcycle 15.

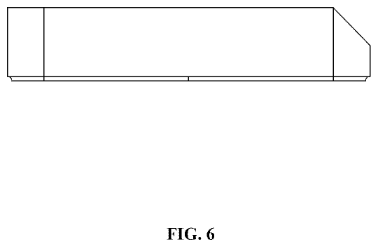

In the example of FIGS. 1A and 5-6, tolerances may be characterized, as such: fractional of +/− 1/16, angular of Mach +/−5°, 0.080-0.130+/−5°, greater than or equal to 0.131+/−1.0°, and/or with two place decimal being +/−0.010 and with three place decimal being+/−0.005. The material of main body 12 may be, e.g., 6061-T6 aluminum, steel, or other material of suitable strength, hardness, and durability, and these or other geometric tolerances may be interpreted per ANSI Y14.5.

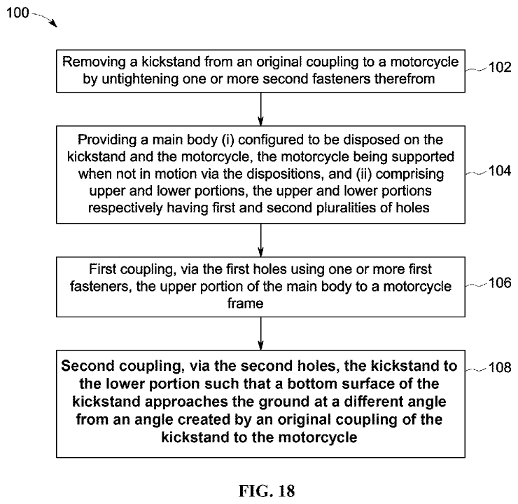

FIG. 18 illustrates method 100 for adjusting the way a kickstand is installed on a vehicle such that an angle that the kickstand, when lowered or activated, approaches a ground differently for causing it to secure slide into a locked position as originally designed when the motorcycle is leaned upon it, in accordance with one or more embodiments. The operations of method 100 presented below are intended to be illustrative. In some embodiments, method 100 may be accomplished with one or more additional operations not described, and/or without one or more of the operations discussed. Additionally, the order in which the operations of method 100 are illustrated in FIG. 18 and described below is not intended to be limiting.

At operation 102 of method 100, a kickstand may be removed from an original coupling to a motorcycle. For example, to begin a contemplated replacement process, kickstand 14 may be de-coupled from motorcycle 15 by untightening one or more of its OEM or stock fasteners.

At operation 104 of method 100, a main body of a side-stand adjustment device may be provided. For example, main body 12 may be configured to be interposed between kickstand 14 and motorcycle 15, the motorcycle being properly secured when not in motion (e.g., parked) via the interposition. In this or another example, main body 12 may comprise upper portion 9 and lower portion 8, the upper and lower portions respectively having upper and lower pluralities of holes as shown in the example of FIGS. 1A-1B.

At operation 106 of method 100, at least the upper portion of the main body may be coupled to a motorcycle frame, via the upper holes using one or more new fasteners. For example, one or more fasteners 17, 18 (e.g., bolt, screw, or other suitable means) may be used for directly coupling main body 12 to motorcycle 15.

At operation 108 of method 100, the kickstand may be coupled to the lower portion of the main body 12, via the lower holes using one or more OEM or stock fasteners. For example, one or more fasteners 19 (e.g., bolt, screw, or other suitable means) may be used for directly coupling kickstand 14 to main body 12 such that main body 12 interposes the motorcycle's frame and the kickstand.

In some embodiments, the foregoing operations are performed by a mechanic or technician with suitable tools to uncouple and re-couple the kickstand (e.g., to a vehicle).

Several embodiments of the disclosure are specifically illustrated and/or described herein. However, it will be appreciated that modifications and variations are contemplated and within the purview of the appended claims.

What is claimed is:

1. A side-stand support device, comprising:
a main body, comprising upper and lower portions, the upper and lower portions respectively having first and second pluralities of holes; and
a first plurality of fasteners configured to first couple the upper portion, via the first holes,
wherein the lower portion of the main body comprises an angle in relation to a vertical axis of the main body such that the second holes cause a second coupling of a kickstand to result in a different angle from an angle created by an original coupling of the kickstand.

2. The device of claim 1, further comprising:
the kickstand.

3. The device of claim 2, wherein the different angle is formed between a bottom surface of the kickstand and a ground or floor, after the second coupling is performed and when the kickstand is in a lowered position,
wherein the angle, created by the original coupling of the kickstand, is formed between the bottom surface of the kickstand and a ground or floor that existed prior to performing the second coupling, and
wherein the bottom surface of the kickstand is substantially flat.

4. The device of claim 3, further comprising:
a second plurality of fasteners configured to perform the second coupling of the kickstand to the lower portion,
wherein the different angle is between 80-100 degrees greater than the angle, created by the original coupling of the kickstand when the kickstand is in the lowered position.

5. The device of claim 2, wherein the kickstand comprises an original equipment manufacturer (OEM) Harley-Davidson™ kickstand for a Milwaukee 8 (M8) Softail series motorcycle.

6. A method, comprising:
providing a main body configured to be disposed on a kickstand and a motorcycle for supporting the motorcycle when not in motion via the dispositions;
said main body, comprising upper and lower portions, the upper and lower portions respectively having first and second pluralities of holes;
first coupling, via the first holes using one or more first fasteners, the upper portion of the main body to a motorcycle frame; and
second coupling the kickstand to the lower portion of the main body,
wherein the second coupling causes the lower portion of the main body to result in an angle different from an angle created by an original coupling of the kickstand to the motorcycle.

7. The method of claim 6, further comprising:
providing one or more second fasteners configured to perform the second coupling of the kickstand to the lower portion of the main body,
wherein the one or more first fasteners are more recently provided than the one or more second fasteners.

8. The method of claim 7, wherein the different angle exists when the kickstand is lowered and the motorcycle is placed into a leaned configuration resting on the kickstand, and
wherein the angle created by the original coupling exists when the kickstand is lowered and the motorcycle is placed into the leaned configuration resting on the kickstand being coupled to the motorcycle without use of the main body.

9. The method of claim 7, further comprising:
before the second coupling, removing the kickstand from the original coupling to the motorcycle by untightening the one or more second fasteners therefrom.

10. The method of claim 6, wherein a spacing between the first holes matches with a spacing between a plurality of predetermined holes of the motorcycle, which are used in the original coupling of the kickstand to the motorcycle.

11. The method of claim 6, further comprising:
removing an original bumper of the kickstand mounted thereat; and
replacing the removed bumper with another bumper having different dimensions than the original bumper.

12. The method of claim 11, wherein the other bumper, when the kickstand is lifted from a lowered configuration, contacts a location of the motorcycle that is within one inch of a location at which the original bumper contacted when lifted from the deployed configuration.

13. The method of claim 11, wherein the bumper replacement is performed using a fastener, a flat washer, a first lock washer operably coupled to the flat washer, and a second washer positioned at an opposite side of the kickstand to (i) cover a hole thereabout and (ii) center the fastener when third coupling the other bumper to the opposite side of the kickstand.

14. The method of claim 6, wherein 30-45 pound-feet (lb·ft) of torque is applied in the first and second couplings.

15. The method of claim 6, further comprising:
protecting, via a protrusion at a front surface of the main body, a spring associated with the kickstand.

16. The method of claim 8, wherein a degree of the leaned configuration in relation to the ground or floor is increased from the degree of the leaned configuration in relation to the ground that resulted from the original coupling of the kickstand to the motorcycle without the main body disposed therebetween.

17. A method, comprising:
removing a kickstand from an original coupling to a motorcycle by untightening one or more second fasteners therefrom;
providing a main body (i) configured to be coupled between a motorcycle and a kickstand that supports the motorcycle when the motorcycle is not in motion, and (ii) comprising upper and lower portions, the upper and lower portions respectively having first and second pluralities of holes;
performing a first coupling, via the first holes using one or more first fasteners, of the upper portion of the main body to a motorcycle frame; and
before or after performing a first coupling, performing a second coupling of the kickstand to the lower portion of the main body.

18. The method of claim 17, wherein the lower portion comprises a surface, at an angle in relation to a vertical axis of the main body, such that the second holes cause, via the second coupling, a bottom surface of the kickstand to contact a ground or floor at an angle different from an angle created by the original coupling of the kickstand to the motorcycle.

19. The method of claim 17, wherein the different angle is formed after the kickstand is lowered from a raised position, and
wherein the bottom surface of the kickstand is substantially flat.

20. The method of claim 17, further comprising:
providing a second plurality of fasteners configured to perform the second coupling of the kickstand to the lower portion.
